(19) United States
(12) Patent Application Publication
(10) Pub. No.: US 2022/0391256 A1
(43) Pub. Date: Dec. 8, 2022

(54) NON-TRANSITORY COMPUTER-READABLE STORAGE MEDIUM, INFORMATION PROCESSING APPARATUS, AND MULTIPLEX CONTROL METHOD

(71) Applicant: FUJITSU LIMITED, Kawasaki-shi (JP)

(72) Inventors: Shinya Toyonaga, Kawasaki (JP); Takahisa Suzuki, Yokohama (JP); Ryuichi MATSUKURA, Kawasaki (JP)

(73) Assignee: Fujitsu Limited, Kawasaki-shi (JP)

(21) Appl. No.: 17/694,968

(22) Filed: Mar. 15, 2022

(30) Foreign Application Priority Data
Jun. 7, 2021 (JP) 2021-094958

(51) Int. Cl. G06F 9/50; G06F 9/54; G06F 13/10

(52) U.S. Cl. CPC G06F 9/5038; G06F 9/5044; G06F 9/546; G06F 13/102

(57) ABSTRACT

An information processing apparatus that uses a graphical processing unit (GPU) for inference processing, the information processing apparatus includes a processor. The processor configured to monitor a message output from an application that executes the inference processing. The processor configured to determine, from a pattern of the message, timing of a start and an end of core processing that uses the GPU, the core processing serving as a core of the inference processing. The processor configured to start the core processing when there is no process executing another core processing and accumulates a process identifier that identifies a process of the core processing in a queue when there is a process executing the another core processing in a case where the timing of the start of the core processing is determined.

### CROSS-REFERENCE TO RELATED APPLICATION

This application is based upon and claims the benefit of priority of the prior Japanese Patent Application No. 2021-94958, filed on Jun. 7, 2021, the entire contents of which are incorporated herein by reference.

### FIELD

The embodiment discussed herein is related to a multiplex control program and the like.

### BACKGROUND

In recent years, systems that execute artificial intelligence (AI) processing using a graphical processing unit (GPU) have been increasing. For example, there is a system that performs object detection and the like based on the AI processing of video.

While one GPU processes video transferred from one camera in such a system, the video is sent in fixed cycles so that there is a time for the GPU to be free in a processing gap. In view of the above, it is expected that one GPU accommodates and processes the video transferred from multiple cameras to mutually fill the gaps and make efficient use.

Japanese Laid-open Patent Publication No. 10-301793 and Japanese Laid-open Patent Publication No. 2019-121185 are disclosed as related art.

### SUMMARY

According to an aspect of the embodiments, an information processing apparatus that uses a graphical processing unit (GPU) for inference processing, the information processing apparatus includes: a memory; and a processor coupled to the memory and configured to: monitor a message output from an application that executes the inference processing, determine, from a pattern of the message, timing of a start and an end of core processing that uses the GPU, the core processing serving as a core of the inference processing, and start the core processing when there is no process executing another core processing and accumulates a process identifier that identifies a process of the core processing in a queue when there is a process executing the another core processing in a case where the timing of the start of the core processing is determined.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a reference example of a server that executes multiplex control;

FIG. 2 is a diagram illustrating an example of a server that executes multiplex control according to an embodiment;

FIG. 3A is a diagram illustrating an exemplary functional structure of the server according to the embodiment;

FIG. 3B is a diagram illustrating an exemplary functional structure of the server according to the embodiment;

FIG. 3C is a diagram illustrating an exemplary functional structure of the server according to the embodiment;

FIG. 4 is a diagram illustrating an example of a path-model correspondence table;

FIG. 5 is a diagram illustrating an example of an inference count DB;

FIG. 6 is a diagram illustrating an example of a core start notification queue;

FIG. 7 is a diagram illustrating an example of a transition pattern DB;

FIG. 8A is a diagram (1) for explaining monitoring of execution completion in a GPU;

FIG. 8B is a diagram (2) for explaining the monitoring of the execution completion in the GPU;

FIG. 9A is a diagram illustrating an exemplary flowchart of a state management unit according to the embodiment;

FIG. 9B is a diagram illustrating an exemplary flowchart of a state management unit according to the embodiment;

FIG. 10 is a diagram illustrating an exemplary hardware structure of the server;

FIG. 11A is a diagram illustrating an exemplary sequence of each module of the server according to the embodiment;

FIG. 11B is a diagram illustrating an exemplary sequence of each module of the server according to the embodiment;

FIG. 12A is a diagram (1) illustrating an exemplary sequence of inference of multiple processes;

FIG. 12B is a diagram (2) illustrating an exemplary sequence of the inference of multiple processes; and

FIG. 13 is a diagram for explaining an increase in processing time caused by interference between processes.

### DESCRIPTION OF EMBODIMENTS

In the related art, when one GPU executes multiple processes in a multiplex manner, there may be a case where a processing time increases due to interference between processes.

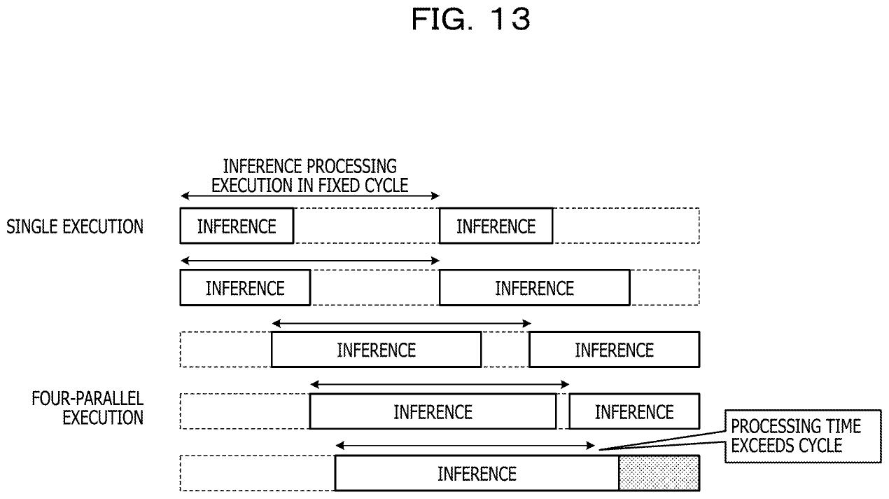

Here, a case where the processing time increases due to the interference between the processes will be described with reference to FIG. 13. FIG. 13 is a diagram for explaining an increase in processing time caused by interference between processes. As illustrated in FIG. 13, one GPU is capable of processing multiple tasks in a multiplex manner. Here, task processing is video inference processing, and four processes are executed in parallel.

In a case of singly executing the video inference processing, the GPU executes the inference processing in predetermined fixed cycles. However, when the GPU executes four series of the video inference processing in parallel, the inference processing may interfere with each other, and the processing time may increase. A degree of the increase in processing time differs depending on contents and a manner of overlapping of the inference processing. For example, the degree of the increase in processing time increases as an overlap between inference processes increases and the number of overlapping of the inference processes increases. Since the start timing of the inference processing is different, when there happens to be many inference processes that start close to each other, the number of overlapping of the inference processes increases, the degree of the increase in processing time increases, and the processing time of the inference process exceeds a fixed cycle. In this way, the processing time increases due to the interference between the processes.

In one aspect, the embodiment aims to suppress an increase in processing time caused by duplicate execution of processes even when one GPU executes multiple processes in a multiplex manner.

Hereinafter, an embodiment of a multiplex control program, an information processing apparatus, and a multiplex control method disclosed in the present application will be described in detail with reference to the drawings. Note that the present disclosure is not limited to the embodiment.

[Server for Executing Multiplex Control]

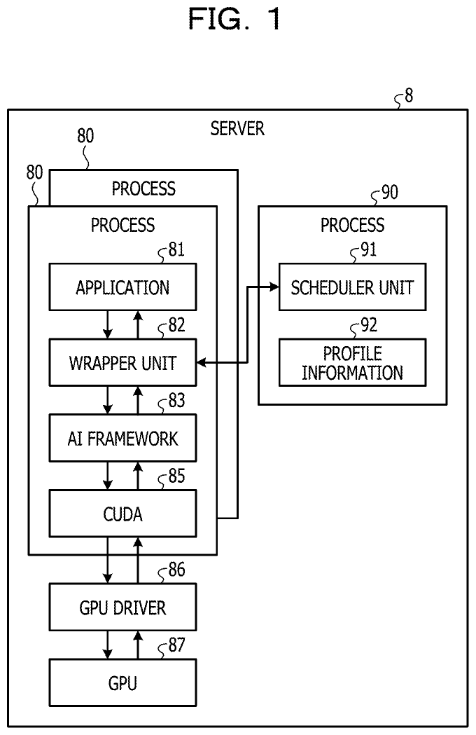

First, a reference example of a server that executes multiplex control when one GPU executes multiple inference processes in a multiplex manner will be described with reference to FIG. 1. FIG. 1 is a diagram illustrating a reference example of the server that executes multiplex control. A server 8 executes a process 80 for inference processing regarding a moving image (video), for example, using a graphics processing unit (GPU) 87. The server 8 is assumed to execute a plurality of the processes 80 in one GPU 87. The process 80 for the inference processing mentioned here refers to an application that estimates a suspicious person or estimates a traffic volume from video, for example. The process 80 incorporates a predetermined library of a compute unified device architecture (CUDA) 85, and executes inference processing using an inference model.

The inference processing involves three phases. The three phases are preprocessing, convolution processing, and postprocessing, and characteristics of each of the processing are different. The preprocessing includes, for example, CPU processing for preparing processing data such as a data source, and data transfer processing for transferring data from a CPU to the GPU 87. The convolution processing is, for example, data processing using the GPU 87, which is a core part of deep learning, and is executed using a convolutional neural network. The postprocessing includes, for example, data transfer processing for transferring a processing result from the GPU 87 to the CPU, and CPU processing for extracting and processing the processing result. Note that the convolution processing will be referred to as core processing or GPU processing hereinafter.

The server 8 controls execution timing in such a manner that the core processing is not duplicately executed when performing multiple inference processes simultaneously. For example, the server 8 causes a subsequent inference process of another application to be delayed by a threshold value or more from the start time of the inference process executed immediately before and to start.

The process for the inference processing (inference process) 80 mentioned here includes an application 81, a wrapper unit 82, an AI framework 83, and a compute unified device architecture (CUDA) 85. The server 8 controls the execution timing of the core processing using the GPU 87 using an interface between the wrapper unit 82 between the application 81 and the AI framework 83 and a scheduler unit 91 executed in another process 90.

The AI framework 83 is a library for executing inference, and calls GPU processing (core processing) for using the library of the CUDA 85. The CUDA 85 is a library for using the GPU 87. A GPU driver 86 is software for running the GPU 87.

The application 81 requests the wrapper unit 82 to start model loading of the inference model, and requests the wrapper unit 82 to perform inference of each frame.

When the wrapper unit 82 receives the inference request from the application 81, it causes the AI framework 83 to execute the inference processing on the basis of an instruction from the scheduler unit 91.

In a case of causing a plurality of the inference processes 80 to be executed in a multiplex manner, the scheduler unit 91 instructs the wrapper unit 82 of the subsequent inference process 80 to start inference to delay the start timing of the subsequent inference process by a predetermined threshold value. In one example, the predetermined threshold value indicates a value of a processing time in a phase of convolution processing (core processing) in a case where the inference models used in the inference processes 80 are the same. This is because the processing time of the convolution processing is substantially the same when the inference model is the same. In another example, the predetermined threshold value indicates a value of a processing time of the sum of the preprocessing and the convolution processing (core processing) in a case where the inference models used in the inference processes 80 are different.

The predetermined threshold value is measured or investigated by a benchmark or the like in advance, and is stored in profile information 92. Then, in a case where two inference processes 80 are executed at close timings, the scheduler unit 91 refers to the profile information 92 to obtain a predetermined threshold value corresponding to the inference model. Then, the scheduler unit 91 delays the start timing of the subsequent inference process 80 by the predetermined threshold value from the start timing of the preceding inference process 80 and issues a start instruction, whereby it becomes possible to suppress an increase in processing time caused by interference.

However, while the server 8 described in the reference example may suppress the increase in processing time caused by interference of core processing, there is a problem that the cost needed for the preliminary investigation for obtaining the predetermined threshold value is high. In view of the above, in the embodiment to be described below, a case will be described in which the cost needed for the preliminary investigation is removed and the increase in processing time caused by the interference of the core processing is suppressed.

### Embodiment

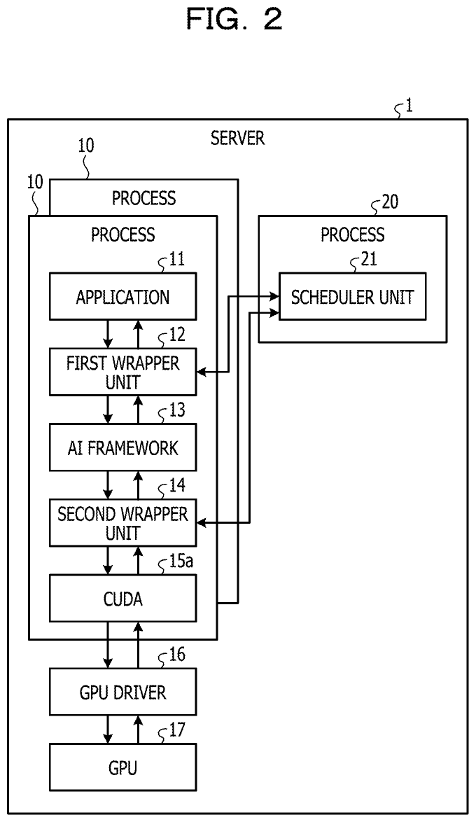

FIG. 2 is a diagram illustrating an example of a server that executes multiplex control according to an embodiment. A server 1 according to the embodiment monitors a message (instruction) that calls core processing, and determines start and end timings of the core processing of inference processing from a message pattern. Then, the server 1 starts the inference processing if there is no process executing the core processing, and stands by for a start notification if there is a running process.

A process for inference processing (inference process) 10 to be described here includes an application 11, a first wrapper unit 12, an AI framework 13, a second wrapper unit 14, and a CUDA 15a. The server 1 uses the second wrapper unit 14 between the AI framework 13 and the CUDA 15a to monitor the message (instruction) that calls the core processing, and determines the start and end timings of the core processing of the inference processing from the message pattern.

The AI framework 13 is a library for executing inference, and calls GPU processing (core processing) for using a library of the CUDA 15a through the second wrapper unit 14. The CUDA 15a is a library for using the GPU 17. A GPU driver 16 is software for running the GPU 17.

The application 11 requests the first wrapper unit 12 to start model loading of an inference model, and requests the first wrapper unit 12 to perform inference of each frame.

The first wrapper unit 12 notifies the scheduler unit 21 executed in another process 20 of the start of the model loading in response to the model loading start request from the application 11, and also generates an inference model. Furthermore, the first wrapper unit 12 notifies the scheduler unit 21 of an inference start notification and a model name in response to the inference request from the application 11. Then, the first wrapper unit 12 starts the inference processing on the basis of an inference start instruction from the scheduler unit 21.

The second wrapper unit 14 hooks a GPU processing call message (instruction) from the AI framework 13, and manages an inference state from a pattern of the call message using a transition pattern. Examples of the inference state include a preprocessing state, a core processing state, and a postprocessing state. The second wrapper unit 14 determines a transition pattern of the start of the core processing when the inference state is preprocessing, determines a transition pattern of the end of the core processing when the inference state is core processing, and determines neither of them when the inference state is postprocessing. When the second wrapper unit 14 detects the start of the core processing, it notifies the scheduler unit 21 of the start of the core processing, and stands by for an instruction from the scheduler unit 21 to start the core processing. Then, when the second wrapper unit 14 receives an instruction to start the core processing from the scheduler unit 21, it starts using the GPU for the core processing. Furthermore, when the second wrapper unit 14 detects the end of the core processing, it notifies the scheduler unit 21 of the end of the core processing, and continues the subsequent postprocessing.

When the scheduler unit 21 receives a first inference start notification from the first wrapper unit 12, the scheduler unit 21 transmits an inference start instruction to the first wrapper unit 12. The scheduler unit 21 causes the second wrapper unit 14 to initialize the state management when the scheduler unit 21 receives second and subsequent inference start notifications from the first wrapper unit 12, and transmits an inference start instruction to the first wrapper unit 12 when the scheduler unit 21 receives a state management initialization completion notification from the second wrapper unit 14.

Furthermore, when the scheduler unit 21 receives a core processing start notification from the second wrapper unit 14, the scheduler unit 21 instructs the second wrapper unit 14 to start the core processing if there is no other inference process 10 executing the core processing. If there is another inference process 10 executing the core processing, the scheduler unit 21 accumulates process ID of the corresponding inference process 10. Then, when the scheduler unit 21 receives a core processing end notification from the second wrapper unit 14, the scheduler unit 21 instructs the second wrapper unit 14 of the inference process 10 indicated by the process ID of one of the accumulated process IDs to start the core processing if the process IDs are accumulated.

[Exemplary Functional Structure of Server]

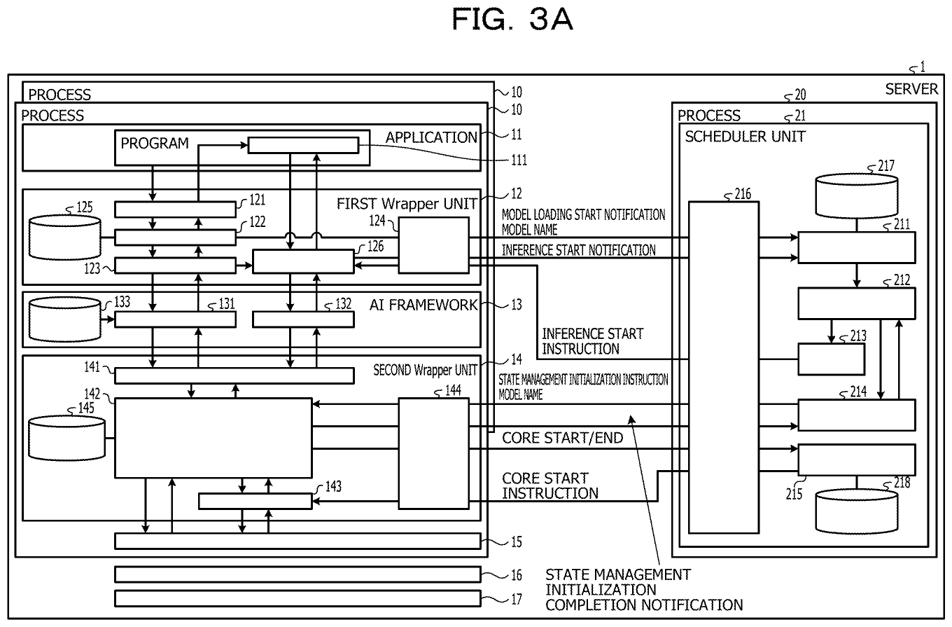

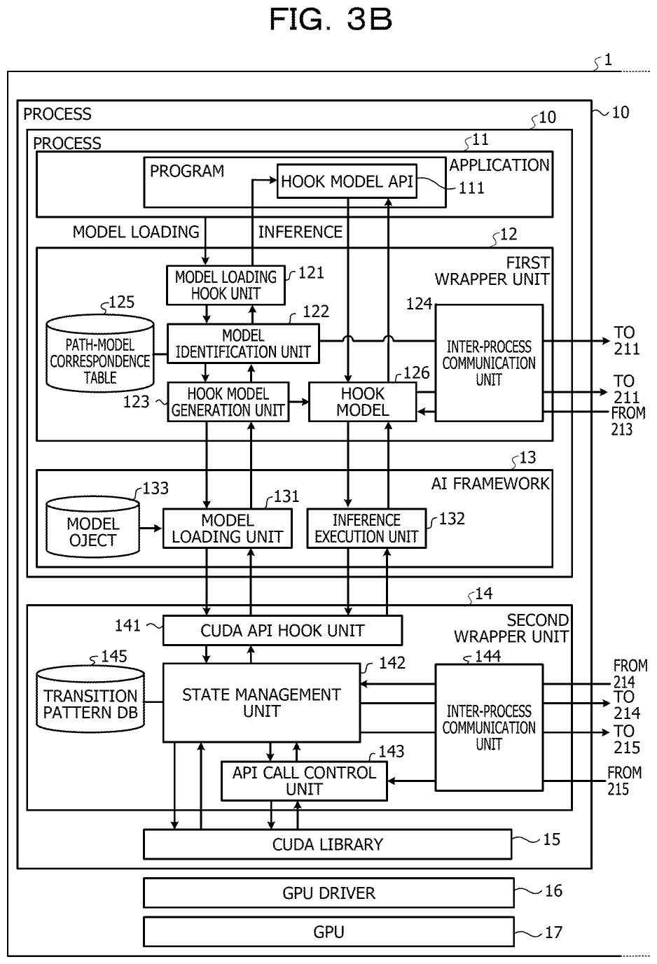

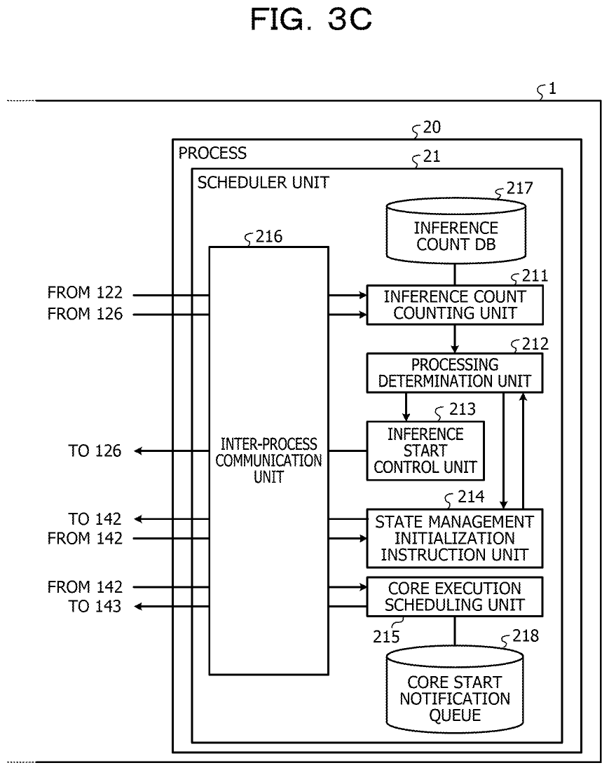

An exemplary functional structure of the server 1 that executes such multiplex control will be described with reference to FIGS. 3A to 3C. FIGS. 3A to 3C are a diagram illustrating an exemplary functional structure of the server according to the embodiment. As illustrated in FIGS. 3A to 3C, the server 1 includes the process 10 that performs inference processing and the process 20 different from the process 10. There is a plurality of the processes 10 that performs the inference processing. Furthermore, the server 1 includes the GPU driver 16 and the GPU 17.

The process 10 includes the application 11, the first wrapper unit 12, the AI framework 13, the second wrapper unit 14, and a CUDA library 15. The process 20 includes the scheduler unit 21. Note that the CUDA library 15 is interchangeable with the CUDA 15a illustrated in FIG. 2.

The first wrapper unit 12 includes a model loading hook unit 121, a model identification unit 122, a hook model generation unit 123, an inter-process communication unit 124, a path-model correspondence table 125, and a hook model 126.

The model loading hook unit 121 hooks a model loading instruction from the application 11, and passes the model loading instruction and the path of the model to be loaded to the model identification unit 122.

The model identification unit 122 obtains a model name to be loaded from the path-model correspondence table 125 to be described later and the path of the model to be loaded. Then, the model identification unit 122 transmits, to the scheduler unit 21, a model loading start notification, process ID of the process 10 of its own, and the obtained model name. Then, the model identification unit 122 passes the path of the model to be loaded to the hook model generation unit 123.

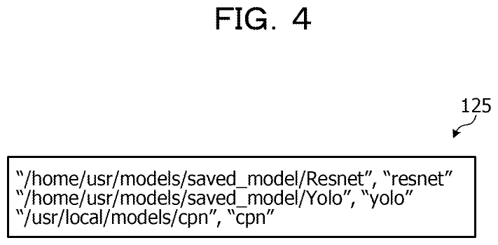

The path-model correspondence table 125 is a list (database (DB)) in which a path where a model object is arranged and a model name are associated with each other, which is registered by an administrator, for example. Here, an example of the path-model correspondence table 125 will be described with reference to FIG. 4. FIG. 4 is a diagram illustrating an example of the path-model correspondence table. As illustrated in FIG. 4, the path-model correspondence table 125 is a table in which paths and model names are associated with each other. While the path-model correspondence table 125 is in a csv format in the example of FIG. 4, it is not limited thereto. The path indicates a path where a model resides. The model name is a name of the model. As an example, the model with the model name “yolo” is stored under the path of “/home/usr/models/saved_model/Yolo”.

Returning to FIGS. 3A to 3C, the hook model generation unit 123 loads the model object of the model to be loaded using a model load application interface (API) of the AI framework 13. Then, the hook model generation unit 123 adds a hook model API (111) and model name information to the model object to generate the hook model 126. Then, the hook model generation unit 123 returns the hook model API (111) to the application 11 via the model identification unit 122 and the model loading hook unit 121.

The hook model 126 hooks the inference start instruction when the inference is executed from the application 11 using the hook model API (111). Then, the hook model 126 transmits the inference start notification, the process ID, and the model name to the scheduler unit 21, and stands by for an instruction from the scheduler unit 21. When the hook model 126 receives the inference start instruction from the scheduler unit 21, the hook model 126 executes the inference using the model object. Then, the hook model 126 returns an execution result to the application 11.

The inter-process communication unit 124 performs communication between the first wrapper unit 12 in the process 10 of its own and the scheduler unit 21 in the process 20.

The AI framework 13 includes a model loading unit 131, an inference execution unit 132, and a model object 133.

The model loading unit 131 obtains the model object 133 of the model to be loaded in response to the request of the first wrapper unit 12. The inference execution unit 132 executes the inference in response to the request of the first wrapper unit 12. For example, the inference execution unit 132 transmits, to the second wrapper unit 14, a CUDA API indicating an API for the CUDA library 15 to execute the inference.

The second wrapper unit 14 includes a CUDA API hook unit 141, a state management unit 142, an API call control unit 143, an inter-process communication unit 144, and a transition pattern DB 145. Note that, the CUDA API hook unit 141 is an example of a monitoring unit. The state management unit 142 is an example of a determination unit.

The CUDA API hook unit 141 hooks the CUDA API. For example, when the CUDA API hook unit 141 hooks the CUDA API from the AI framework 13, it passes the CUDA API and an argument to the state management unit 142.

The state management unit 142 manages an inference state.

For example, when the state management unit 142 receives a state management initialization instruction including the model name from the scheduler unit 21, the state management unit 142 loads the transition pattern corresponding to the model name from the transition pattern DB 145 to be described later, and initializes internal variables for state management. Then, the state management unit 142 transmits a state management initialization completion notification to the scheduler unit 21. The transition pattern DB 145 mentioned here is a DB that retains transition patterns, which are registered by, for example, an administrator. The transition pattern includes information regarding a model name, a core start pattern, and a core end pattern. Note that descriptions of the transition pattern DB 145 will be given later.

Furthermore, the state management unit 142 updates internal variables of the state and the like from the CUDA API and the argument passed when the CUDA API is hooked on the basis of the loaded transition pattern. The state mentioned here indicates the current state, and includes a preprocessing state, a core processing state, and a postprocessing state. As an example, in a case where a return value when the CUDA API is executed is included in the transition condition indicated in the transition pattern, the state management unit 142 transmits a CUDA API execution instruction to the CUDA library 15, and updates the internal variables of the state and the like based on the return value for the execution instruction. For example, when the state management unit 142 receives the return value for the execution instruction, the state management unit 142 updates the state from the preprocessing to the core processing.

Furthermore, when the state management unit 142 detects the core start pattern based on the loaded transition pattern, the state management unit 142 transmits, to the scheduler unit 21, a core start notification and the process ID of the process 10 of its own. Thereafter, in a case where the CUDA API is not executed when the internal variable is updated, the state management unit 142 passes the CUDA API and the argument to the API call control unit 143. In a case where the CUDA API has already been executed when the internal variable is updated, the state management unit 142 passes the return value corresponding to the execution of the CUDA API to the API call control unit 143.

Furthermore, when the state management unit 142 detects the core end pattern based on the loaded transition pattern, the state management unit 142 transmits, to the scheduler unit 21, a core end notification and the process ID of the process 10 of its own. Thereafter, in a case where the CUDA API is not executed when the internal variable is updated, the state management unit 142 executes the CUDA API, and returns the return value corresponding to the execution to the AI framework 13 via the CUDA API hook unit 141. In a case where the CUDA API has already been executed when the internal variable is updated, the state management unit 142 returns the return value corresponding to the execution to the AI framework 13 via the CUDA API hook unit 141.

Furthermore, in a case where neither the core start nor the core end is detected, the state management unit 142 performs the following process. In a case where the CUDA API is not executed when the internal variable is updated, the state management unit 142 executes the CUDA API, and returns the return value corresponding to the execution to the AI framework 13 via the CUDA API hook unit 141. In a case where the CUDA API has already been executed when the internal variable is updated, the state management unit 142 returns the return value corresponding to the execution to the AI framework 13 via the CUDA API hook unit 141.

The API call control unit 143 controls calling of the CUDA API. For example, when the API call control unit 143 receives, from the state management unit 142, the CUDA API and the argument or the return value, it stands by for the core start instruction from the scheduler unit 21. In a case where the API call control unit 143 has received the CUDA API and the argument at a time of receiving the core start instruction from the scheduler unit 21, it executes the corresponding CUDA API. Then, the API call control unit 143 returns the return value corresponding to the execution to the state management unit 142. Furthermore, in a case where the API call control unit 143 has received the return value at a time of receiving the core start instruction from the scheduler unit 21, the API call control unit 143 returns the corresponding return value to the state management unit 142.

The inter-process communication unit 144 performs inter-process communication between the second wrapper unit 14 in the process 10 of its own and the scheduler unit 21 in the process 20.

The scheduler unit 21 includes an inference count counting unit 211, a processing determination unit 212, an inference start control unit 213, a state management initialization instruction unit 214, a core execution scheduling unit 215, and an inter-process communication unit 216. Furthermore, the scheduler unit 21 includes an inference count DB 217 and a core start notification queue 218. Note that, the core execution scheduling unit 215 is an example of a control unit. The core start notification queue 218 is an example of a storage unit.

The inference count counting unit 211 counts the number of times of inference. For example, when the model loading start notification, the process ID, and the model name are received from the first wrapper unit 12, the inference count counting unit 211 sets the inference count as zero for the combination of the process ID and the model name, and registers them in the inference count DB 217 to be described later. Furthermore, when the inference count counting unit 211 receives the inference start notification, the process ID, and the model name from the first wrapper unit 12, it obtains the inference count corresponding to the combination of the process ID and the model name from the inference count DB 217, adds one to the obtained inference count, and updates the inference count DB 217. Then, the inference count counting unit 211 passes the process ID, the model name, and the registered or updated inference count to the processing determination unit 212. The inference count DB 217 mentioned here is a DB that retains the inference count for each combination of the process ID and the model name.

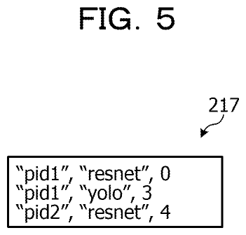

Here, an example of the inference count DB 217 will be described with reference to FIG. 5. FIG. 5 is a diagram illustrating an example of the inference count DB. As illustrated in FIG. 5, the inference count DB 217 stores a process ID, a model name, and a count in association with each other. While the inference count DB 217 is in a csv format in the example of FIG. 5, it is not limited thereto. The process ID is ID for identifying the process 10. The model name is a name of the model. The count indicates the number of times of inference. As an example, “3” is stored as an inference count in a case where the process ID is “pid1” and the model name is “yolo”.

Returning to FIGS. 3A to 3C, the processing determination unit 212 performs the following process when the processing determination unit 212 receives the process ID, the model name, and the inference count from the inference count counting unit 211. When the inference count is “1”, the processing determination unit 212 transmits the process ID to the inference start control unit 213 to cause an inference start instruction to be transmitted. Furthermore, when the inference count is two or more, the processing determination unit 212 transmits the process ID and the model name to the state management initialization instruction unit 214 to cause a state management initialization instruction to be transmitted. Then, when the processing determination unit 212 receives a state management initialization completion notification from the state management initialization instruction unit 214, the processing determination unit 212 transmits the process ID to the inference start control unit 213 to cause the inference start instruction to be transmitted.

When the state management initialization instruction unit 214 receives the process ID and the model name from the processing determination unit 212, the state management initialization instruction unit 214 transmits the state management initialization instruction including the model name to the second wrapper unit 14 of the process 10 indicated by the process ID. Then, the state management initialization instruction unit 214 stands by for a response from the second wrapper unit 14. Then, when the state management initialization instruction unit 214 receives the state management initialization completion notification from the second wrapper unit 14, the state management initialization instruction unit 214 returns the state management initialization completion notification to the processing determination unit 212.

When the inference start control unit 213 receives the process ID from the processing determination unit 212, the inference start control unit 213 transmits the inference start instruction to the first wrapper unit 12 of the process 10 indicated by the process ID.

The core execution scheduling unit 215 schedules execution of the core processing. For example, the core execution scheduling unit 215 performs the following process when it receives a core start notification and the process ID from the second wrapper unit 14. When the core start notification queue 218 to be described later is empty, there is no process 10 executing the core processing, and the core execution scheduling unit 215 transmits the core start instruction to the second wrapper unit 14 of the process 10 indicated by the process ID, accordingly. Then, the core execution scheduling unit 215 adds the process ID to the core start notification queue 218. When the core start notification queue 218 is not empty, there is a process 10 executing the core processing, and the core execution scheduling unit 215 adds the process ID to the core start notification queue 218, accordingly. When the core execution scheduling unit 215 receives a core end notification and the process ID from the second wrapper unit 14, the core execution scheduling unit 215 deletes the corresponding process ID from the core start notification queue 218. Then, the core execution scheduling unit 215 selects any of the process IDs from the core start notification queue 218, and transmits a core start instruction to the second wrapper unit 14 of the process 10 indicated by the selected process ID.

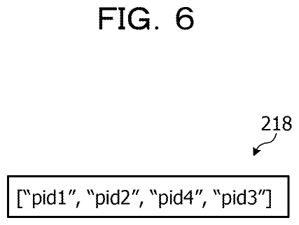

The core start notification queue 218 mentioned here is a queue that accumulates the process ID of the process 10 in which the core start has been detected. One of the process IDs accumulated in the core start notification queue 218 is the process ID of the process 10 actually executing the core processing, and other accumulated process IDs are process IDs of the processes 10 standing by for the execution of the core processing. Here, an example of the core start notification queue 218 will be described with reference to FIG. 6. FIG. 6 is a diagram illustrating an example of the core start notification queue. As illustrated in FIG. 6, the process ID of the process executing the core processing or standing by for the execution is accumulated in the core start notification queue 218. As an example, “pid1”, “pid2”, “pid4”, and “pid3” are accumulated as process IDs.

The inter-process communication unit 216 performs inter-process communication between the scheduler unit 21 in the process 20 of its own and the process 10.

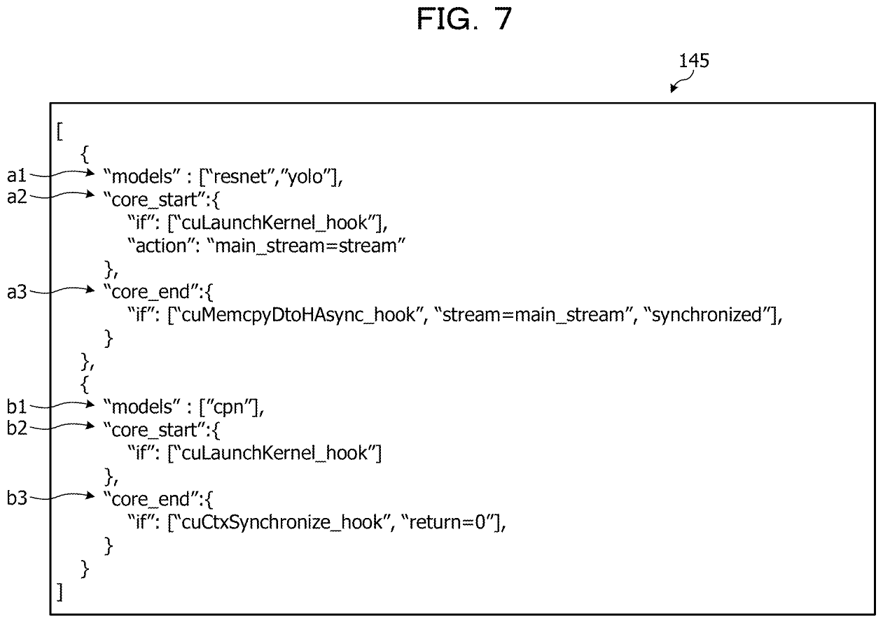

Here, an example of the transition pattern DB 145 will be described with reference to FIG. 7. FIG. 7 is a diagram illustrating an example of the transition pattern DB. As illustrated in FIG. 7, the transition pattern DB 145 stores a model name, a core start pattern, and a core end pattern in association with each other. While the transition pattern DB 145 is in a json format in the example of FIG. 7, it is not limited thereto.

Fields of “models” indicated by reference signs a1 and b1 are lists of model names corresponding to transition patterns. Fields of “core_start” indicated by reference signs a2 and b2 are core start patterns of the CUDA API for determining a core start. Fields of “core_end” indicated by the reference signs a3 and b3 are core end patterns of the CUDA API for determining a core end.

Furthermore, an “if” field indicates determination conditions for determining the core start or the core end. In a case of ““if”:[[A, B], [C], [D]]”, it indicates “(A and B) or C or D”. Furthermore, “◯◯_hook” indicates that a condition is that the CUDA API to be hooked is ◯◯. Furthermore, ““stream=main_stream”” indicates that a condition is that the stream of the argument of the CUDA API to be hooked matches the mainstream. Furthermore, ““return=0”” indicates that a condition is that the return value of the execution of the CUDA API is “0”. Furthermore, “synchronized” indicates that a condition is that the execution of the hooked CUDA API in the GPU 17 is complete. In this manner, in the transition pattern DB 145, it is possible to define three patterns of when a specific CUDA_API is hooked, when a specific CUDA_API is executed and a return value is obtained, and when execution of a specific CUDA_API in the GPU 17 is complete as the determination conditions for determining the core start or the core end.

Furthermore, an “action” field is a field to be used to cause an action. For example, ““main_stream=stream”” indicates that a stream number of the argument of the hooked CUDA_API is set as a mainstream variable contained in the internal variables.

As an example, in a case where the “models” field is “resnet” or “yolo”, the “if” field is described as “cuLaunchKernel_hook” as the “core_start” field. The description “cuLaunchKernel_hook” indicates that a condition is that the CUDA API to be hooked is cuLaunchKernel. In addition, the “action” field is described as “main_stream=stream”. Furthermore, the “if” field is described as [“cuMemcpyDtoHAsync_hook”, “stream=main_stream”, “synchronized”] as the “core_end” field.

As another example, in a case where the “models” field is “cpn”, the “if” field is described as “cuLaunchKernel_hook” as the “core_start” field. The description “cuLaunchKernel_hook” indicates that a condition is that the CUDA API to be hooked is cuLaunchKernel. Furthermore, the “if” field is described as ““cuCtxSynchronize_hook”, “return=0”” as the “core_end” field. Since ““return=0”” is described, it indicates that a condition is that the return value of the execution of the CUDA API is “0”.

Here, an exemplary process of the state management unit 142 based on the transition pattern will be described. For example, when the state management unit 142 receives a state management initialization instruction including the model name from the scheduler unit 21, the state management unit 142 loads the transition pattern corresponding to the model name from the transition pattern DB 145. The transition pattern stored in the transition pattern DB 145 in which the model name in the “models” field matches the received model name is loaded. Then, the state management unit 142 initializes the internal variables for state management. The internal variables include a state, a mainstream variable, a monitoring target stream variable, and a monitoring target event variable. The state includes three states of preprocessing, core processing, and postprocessing, and the preprocessing is set at the time of initialization. Then, the state management unit 142 transmits a state management initialization completion notification to the scheduler unit 21.

Then, the state management unit 142 starts state management based on the loaded transition pattern. When the current state is the preprocessing, the state management unit 142 identifies the core start pattern each time the CUDA API and the argument are passed from the CUDA API hook unit 141. Specifically, for example, the state management unit 142 determines a condition of the “core_start” field of the transition pattern. As an example, in a case where “synchronized” is included in the “if” field, when a CUDA API that satisfies other conditions in the “if” field is hooked, the state management unit 142 monitors execution of the corresponding CUDA API in the GPU 17 until it is complete. When the state management unit 142 detects the execution completion in the GPU 17, the state management unit 142 determines that the conditions are satisfied. Note that the monitoring of the execution completion in the GPU 17 will be described later. Furthermore, when the conditions include the “action” field, the state management unit 142 updates the internal variables when the conditions in the “if” field are satisfied.

Then, when the state management unit 142 detects the core start pattern, the state management unit 142 updates the current state from the preprocessing to the core processing. Then, the state management unit 142 transmits the CUDA API and the argument to the API call control unit 143. Thereafter, the state management unit 142 notifies the scheduler unit 21 of the core start. Then, when the state management unit 142 receives a return value from the API call control unit 143, the state management unit 142 returns the return value to the CUDA API hook unit 141.

When the current state is the core processing, the state management unit 142 identifies the core end pattern each time the CUDA API and the argument are passed from the CUDA API hook unit 141. Specifically, for example, the state management unit 142 determines a condition of the “core_end” field of the transition pattern. As an example, in a case where “synchronized” is included in the “if” field, when a CUDA API that satisfies other conditions in the “if” field is hooked, the state management unit 142 monitors execution of the corresponding CUDA API in the GPU 17 until it is complete. When the state management unit 142 detects the execution completion in the GPU 17, it determines that the conditions are satisfied. Note that the monitoring of the execution completion in the GPU 17 will be described later.

Then, when the state management unit 142 detects the core end pattern, the state management unit 142 updates the current state from the core processing to the postprocessing. Thereafter, the state management unit 142 notifies the scheduler unit 21 of the core end.

Note that, at a time other than the above, the state management unit 142 executes the CUDA API passed from the CUDA API hook unit 141, and returns a return value to the CUDA API hook unit 141.

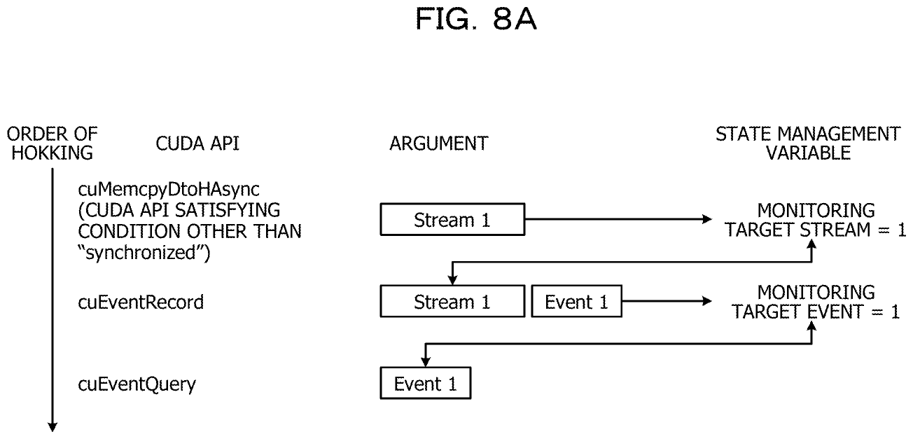

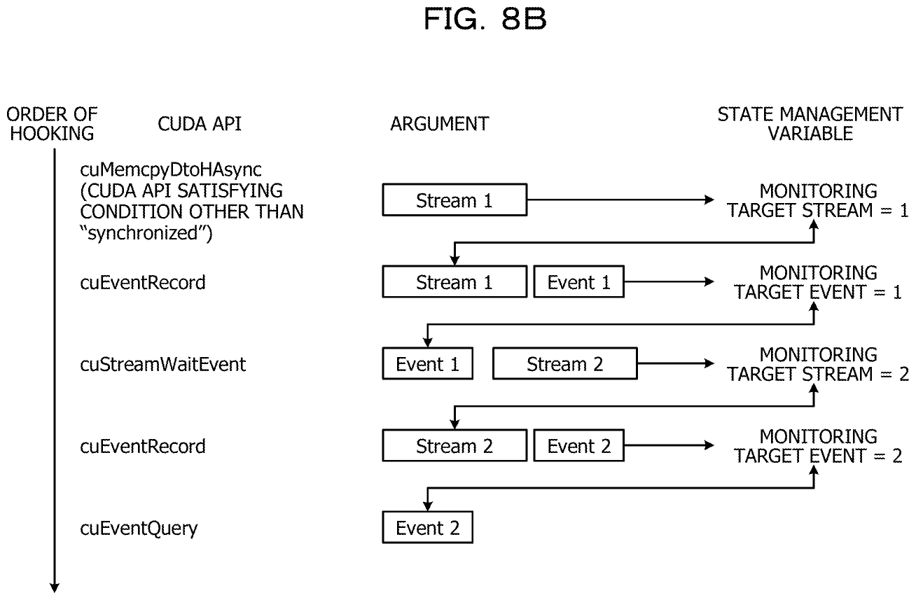

Here, the monitoring of the execution completion in the GPU 17 will be described with reference to FIGS. 8A and 8B. FIGS. 8A and 8B are diagrams for explaining the monitoring of the execution completion in the GPU. Note that, FIG. 8A explains a case where “cuStreamWaitEvent” is not hooked in the monitoring, and FIG. 8B explains a case where “cuStreamWaitEvent” is hooked in the monitoring.

As illustrated in FIG. 8A, a case where “cuStreamWaitEvent” is not hooked in the monitoring is represented. First, in a case where “synchronized” is included in the “if” field, the state management unit 142 performs the following process when a CUDA API that satisfies other conditions in the “if” field is hooked. The state management unit 142 sets the stream number of the argument of the corresponding CUDA API as a monitoring target stream variable serving as an internal variable for state management. Here, the CUDA API to be monitored is “cuMemcpyDtoHAsync”, and the argument is “Stream 1”. In such a case, “1” in the argument “Stream” is set as the monitoring target stream variable serving as an internal variable.

Next, when the CUDA API of “cuEventRecord” is hooked, the state management unit 142 performs the following process if the stream number of the argument is the same as the monitoring target stream variable. The state management unit 142 sets the event number of the argument of the corresponding CUDA API as a monitoring target event serving as an internal variable for state management. Here, the CUDA API to be hooked is “cuEventRecord”, and the arguments are “Stream 1” and “Event 1”. In such a case, since the stream number of the argument is the same as the monitoring target stream variable, “1” of the argument “Event” is set as the monitoring target event variable serving as an internal variable.

Next, when the CUDA API of “cuEventQuery” is hooked, the state management unit 142 determines that the execution of the CUDA API to be monitored in the GPU 17 is complete if the event number of the argument is the same as the monitoring target event variable and the return value of the execution of the corresponding CUDA API is “0”. Here, the CUDA API to be hooked is “cuEventQuery”, and the argument is “Event 1”. In such a case, since the event number of the argument is the same as the monitoring target event variable, the execution of the CUDA API to be monitored in the GPU 17 is determined to be complete if the return value of the execution is “0”.

As illustrated in FIG. 8B, a case where “cuStreamWaitEvent” is hooked in the monitoring is represented. First, in a case where “synchronized” is included in the “if” field, the state management unit 142 performs the following process when a CUDA API that satisfies other conditions in the “if” field is hooked. The state management unit 142 sets the stream number of the argument of the corresponding CUDA API as a monitoring target stream variable serving as an internal variable for state management. Here, the CUDA API to be monitored is “cuMemcpyDtoHAsync”, and the argument is “Stream 1”. In such a case, “1” in the argument “Stream” is set as the monitoring target stream variable serving as an internal variable.

Next, when the CUDA API of “cuEventRecord” is hooked, the state management unit 142 performs the following process if the stream number of the argument is the same as the monitoring target stream variable. The state management unit 142 sets the event number of the argument of the corresponding CUDA API as a monitoring target event variable serving as an internal variable for state management. Here, the CUDA API to be hooked is “cuEventRecord”, and the arguments are “Stream 1” and “Event 1”. In such a case, since the stream number of the argument is the same as the monitoring target stream variable, “1” of the argument “Event” is set as the monitoring target event variable serving as an internal variable.

Next, when the CUDA API of “cuStreamWaitEvent” is hooked, the state management unit 142 performs the following process if the event number of the argument is the same as the monitoring target event variable. The state management unit 142 sets the stream number of the argument as a monitoring target stream variable serving as an internal variable for state management. Here, the CUDA API to be hooked is “cuStreamWaitEvent”, and the arguments are “Event 1” and “Stream 2”. In such a case, since the event number of the argument is the same as the monitoring target event variable, “2” of the argument “Stream” is set as the monitoring target stream variable serving as an internal variable.

Next, when the CUDA API of “cuEventRecord” is hooked, the state management unit 142 performs the following process if the stream number of the argument is the same as the monitoring target stream variable. The state management unit 142 sets the event number of the argument of the corresponding CUDA API as a monitoring target event variable serving as an internal variable for state management. Here, the CUDA API to be hooked is “cuEventRecord”, and the arguments are “Stream 2” and “Event 2”. In such a case, since the stream number of the argument is the same as the monitoring target stream variable, “2” of the argument “Event” is set as the monitoring target event variable serving as an internal variable.

Thereafter, when “cuStreamWaitEvent” in which the event number of the argument is the same as the monitoring target event variable is hooked, the state management unit 142 returns to the process when the CUDA API of “cuStreamWaitEvent” described above is hooked.

Then, when the CUDA API of “cuEventQuery” is hooked, the state management unit 142 determines that the execution of the CUDA API to be monitored in the GPU 17 is complete if the event number of the argument is the same as the monitoring target event variable and the return value of the execution of the corresponding CUDA API is “0”. Here, the CUDA API to be hooked is “cuEventQuery”, and the argument is “Event 2”. In such a case, since the event number of the argument is the same as the monitoring target event variable, the execution of the CUDA API to be monitored in the GPU 17 is determined to be complete if the return value of the execution is “0”.

[Flowchart of State Management Unit]

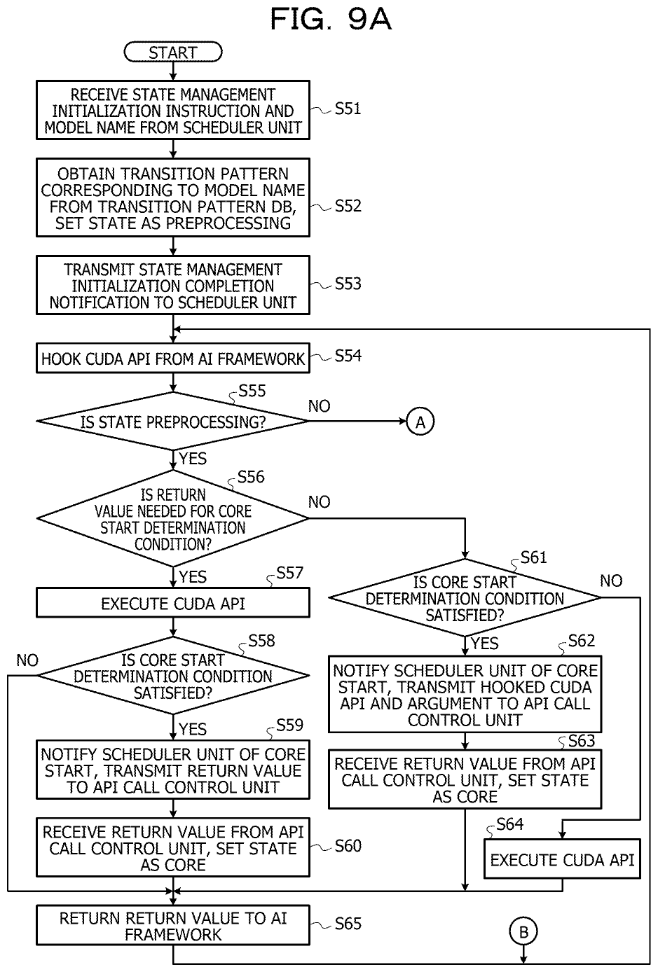

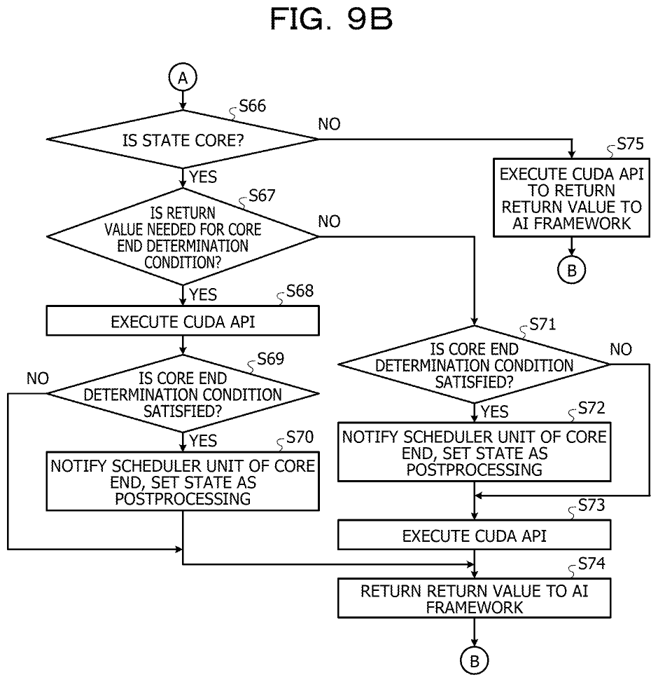

Next, an exemplary flowchart of the state management unit according to the embodiment will be described with reference to FIGS. 9A to 9B. FIGS. 9A to 9B are a diagram illustrating an exemplary flowchart of the state management unit according to the embodiment.

The state management unit 142 receives a state management initialization instruction and a model name from the scheduler unit 21 (step S51). The state management unit 142 obtains a transition pattern corresponding to the model name from the transition pattern DB 145. The state management unit 142 sets a state to be preprocessing (step S52). The obtained transition pattern includes a core start pattern and a core end pattern. The core start pattern includes a core start determination condition. The core end pattern includes a core end determination condition.

The state management unit 142 transmits a state management initialization completion notification to the scheduler unit 21 (step S53). The state management unit 142 hooks the CUDA API from the AI framework 13 (step S54).

The state management unit 142 determines whether or not the state is preprocessing (step S55). If the state is determined to be preprocessing (Yes in step S55), the state management unit 142 determines whether or not a return value is needed for the core start determination condition (step S56). For example, it is a case where “return=0” is set in the core start determination condition. If it is determined that the return value is needed for the core start determination condition (Yes in step S56), the state management unit 142 executes the hooked CUDA API (step S57).

The state management unit 142 determines whether or not the core start determination condition is satisfied as a result of the execution (step S58). When it is determined that the core start determination condition is not satisfied (No in step S58), the state management unit 142 proceeds to step S65.

On the other hand, when it is determined that the core start determination condition is satisfied (Yes in step S58), the state management unit 142 notifies the scheduler unit 21 of the core start. Then, the state management unit 142 transmits a return value to the API call control unit 143 (step S59). Then, the state management unit 142 receives the return value from the API call control unit 143, and sets the state to be core processing (step S60). Then, the state management unit 142 proceeds to step S65.

On the other hand, when it is determined that the return value is not needed for the core start determination condition (No in step S56), the state management unit 142 determines whether or not the core start determination condition is satisfied (step S61). When it is determined that the core start determination condition is satisfied (Yes in step S61), the state management unit 142 notifies the scheduler unit 21 of the core start. Then, the state management unit 142 transmits the hooked CUDA API and the argument to the API call control unit 143 (step S62). Then, the state management unit 142 receives the return value from the API call control unit 143, and sets the state to be core processing (step S63). Then, the state management unit 142 proceeds to step S65.

On the other hand, when it is determined that the core start determination condition is not satisfied (No in step S61), the state management unit 142 executes the hooked CUDA API (step S64). Then, the state management unit 142 proceeds to step S65.

In step S65, the state management unit 142 returns the return value to the AI framework 13 (step S65). Then, the state management unit 142 proceeds to step S54 to hook the next CUDA API.

When it is determined in step S55 that the state is not preprocessing (No in step S55), the state management unit 142 determines whether or not the state is core processing (step S66). When the state is determined to be core processing (Yes in step S66), the state management unit 142 determines whether or not a return value is needed for the core end determination condition (step S67). For example, it is a case where “return=0” is set in the core end determination condition. When it is determined that the return value is needed for the core end determination condition (Yes in step S67), the state management unit 142 executes the hooked CUDA API (step S68).

Then, the state management unit 142 determines whether or not the core end determination condition is satisfied as a result of the execution (step S69). When it is determined that the core end determination condition is not satisfied (No in step S69), the state management unit 142 proceeds to step S74.

On the other hand, when it is determined that the core end determination condition is satisfied (Yes in step S69), the state management unit 142 notifies the scheduler unit 21 of the core end, and sets the state to be postprocessing (step S70). Then, the state management unit 142 proceeds to step S74.

On the other hand, when it is determined that the return value is not needed for the core end determination condition (No in step S67), the state management unit 142 determines whether or not the core end determination condition is satisfied (step S71). When it is determined that the core end determination condition is satisfied (Yes in step S71), the state management unit 142 notifies the scheduler unit 21 of the core end, and sets the state to be postprocessing (step S72). Then, the state management unit 142 proceeds to step S73.

On the other hand, when it is determined that the core end determination condition is not satisfied (No in step S71), the state management unit 142 proceeds to step S73. In step S73, the state management unit 142 executes the hooked CUDA API (step S73). Then, the state management unit 142 proceeds to step S74.

In step S74, the state management unit 142 returns the return value to the AI framework 13 (step S74). Then, the state management unit 142 proceeds to step S54 to hook the next CUDA API.

On the other hand, when the state is determined not to be core processing (No in step S66), the state management unit 142 executes the hooked CUDA API, and returns the return value to the AI framework 13 (step S75). Then, the state management unit 142 proceeds to step S54 to hook the next CUDA API.

[Hardware Structure of Server]

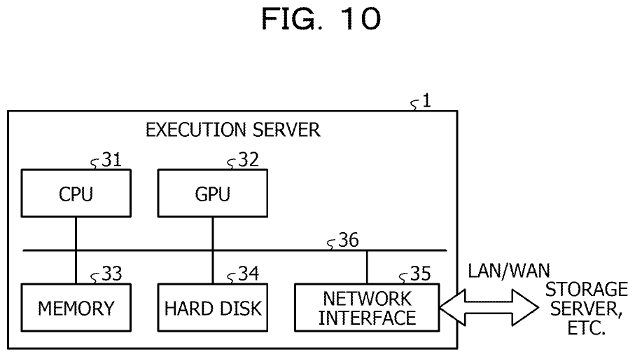

FIG. 10 is a diagram illustrating an exemplary hardware structure of the server. As illustrated in FIG. 10, the server 1 includes a GPU 32 in addition to a CPU 31. Furthermore, the server 1 includes a memory 33, a hard disk 34, and a network interface 35. The respective units illustrated in FIG. 10 are mutually connected by a bus 36, for example.

The network interface 35 is a network interface card or the like, which communicates with another device such as a storage server (not illustrated). The hard disk 34 stores a program for operating the functions illustrated in FIGS. 3A to 3C, the transition pattern DB 145, and the like.

The CPU 31 reads a program for executing processing similar to that of each processing unit illustrated in FIGS. 3A to 3C from the hard disk 34 or the like, and loads it in the memory 33, thereby activating a process that implements each function described with reference to FIGS. 3A to 3C or the like. For example, this process executes a function similar to that of each processing unit included in the server 1. Specifically, for example, the CPU 31 reads, from the hard disk 34 or the like, a program having functions similar to those of the process 10, the process 20, the GPU driver 16, and the like. Then, the CPU 31 executes a process for executing processing similar to that of the process 10, the process 20, the GPU driver 16, and the like.

The GPU 32 reads a program for executing the GPU processing in the inference processing from the hard disk 34 or the like, and loads it in the memory 33, thereby operating the process for executing the corresponding program. The GPU 32 causes a plurality of the processes 10 to operate in a multiplex manner.

[Sequence for Each Module of Server]

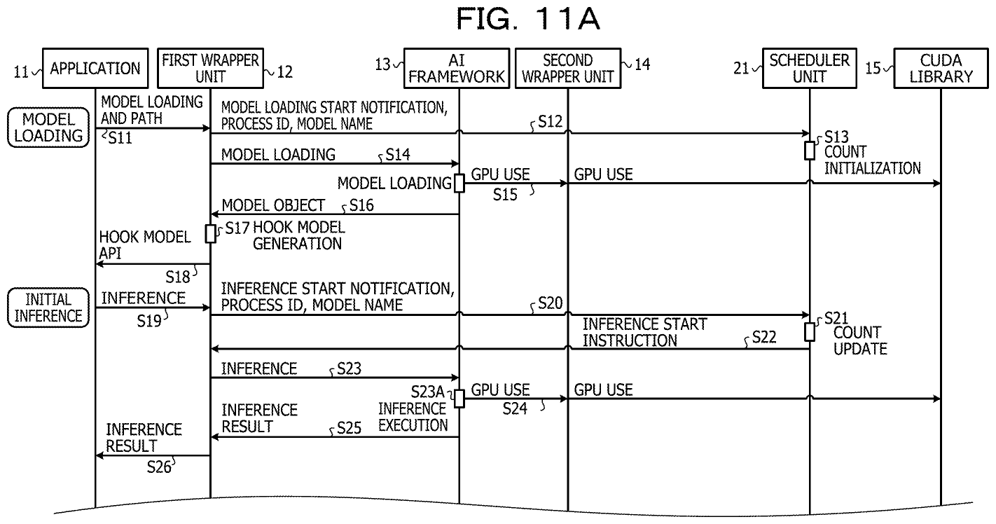

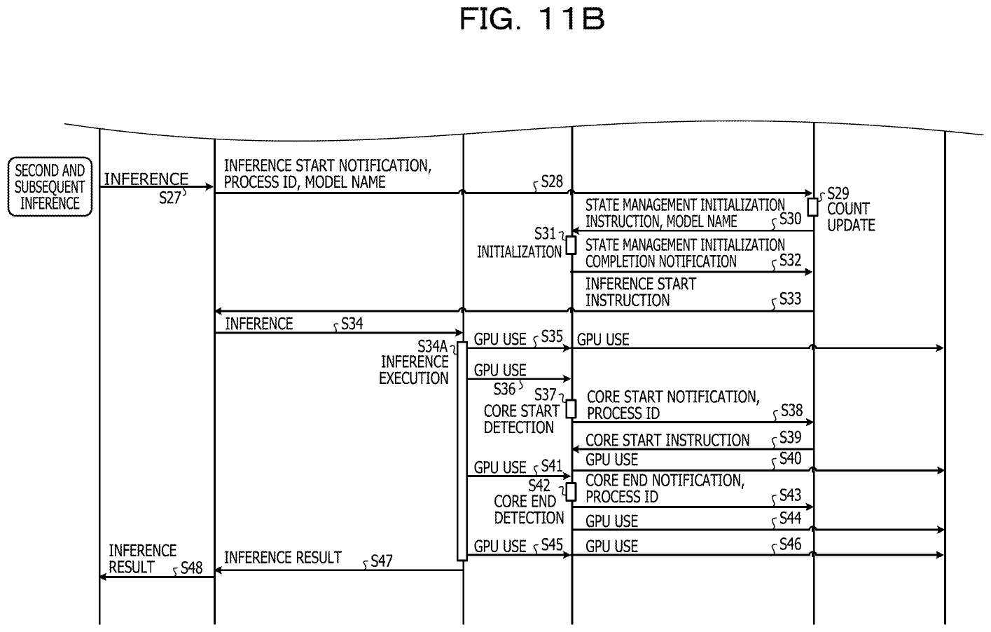

Next, an exemplary sequence of each module of the server according to the embodiment will be described with reference to FIGS. 11A to 11B. FIGS. 11A to 11B are a diagram illustrating an exemplary sequence of each module of the server according to the embodiment.

First, the application 11 transmits a model loading instruction and a path of a model to be loaded to the first wrapper unit 12 (S11). Then, the first wrapper unit 12 hooks the model loading instruction from the application 11. Then, the first wrapper unit 12 obtains a model name to be loaded from the path-model correspondence table 125 and the path of the model to be loaded, and transmits a model loading start notification, a process ID, and the model name to the scheduler unit 21 (S12).

The scheduler unit 21 that has received the model loading start notification, the process ID, and the model name initializes the count of the inference count for the combination of the process ID and the model name (S13).

The first wrapper unit 12 uses the model load API of the AI framework 13 to load a model object with the model name to be loaded (S14 to S16). Thereafter, the first wrapper unit 12 adds information regarding the hook API and the model name to the loaded model object to generate a hook model (S17). Then, the first wrapper unit 12 returns the hook model API (111) to the application 11 (S18).

The application 11 executes the initial inference using the hook model API (111) (S19). Then, in the first wrapper unit 12, the hook model hooks an inference start instruction, and an inference start notification, the process ID, and the model name are transmitted to the scheduler unit 21 (S20). Thereafter, the first wrapper unit 12 stands by for an instruction from the scheduler unit 21.

The scheduler unit 21 that has received the inference start notification, the process ID, and the model name updates the count of the inference count for the combination of the process ID and the model name to a value “1” obtained by adding one thereto (S21). Then, since the inference count is “1” (first time), the scheduler unit 21 transmits an inference start instruction to the first wrapper unit 12 of the process 10 indicated by the process ID (S22).

The first wrapper unit 12 that has received the inference start instruction executes the inference using the model object (S23). The AI framework 13 executes the inference processing using the GPU 17 (S23A, S24). Then, the first wrapper unit 12 returns an inference result to the application 11 upon reception thereof (S25, S26).

Next, the application 11 executes the inference for the second and subsequent times using the hook model API (111) (S27). Then, in the first wrapper unit 12, the hook model hooks the inference start instruction, and the inference start notification, the process ID, and the model name are transmitted to the scheduler unit 21 (S28). Thereafter, the first wrapper unit 12 stands by for an instruction from the scheduler unit 21.

The scheduler unit 21 that has received the inference start notification, the process ID, and the model name updates the count of the inference count for the combination of the process ID and the model name to a value obtained by adding one (S29). Then, since the inference count is “2” or more, the scheduler unit 21 transmits a state management initialization instruction and the model name to the second wrapper unit 14 of the process indicated by the process ID (S30). Then, the scheduler unit 21 stands by for a response from the second wrapper unit 14.

The second wrapper unit 14 that has received the state management initialization instruction and the model name loads a transition pattern corresponding to the model name from the transition pattern DB, and initializes internal variables (S31). Thereafter, the second wrapper unit 14 transmits a state management initialization completion notification to the scheduler unit 21 (S32).

The scheduler unit 21 that has received the state management initialization completion notification transmits an inference start instruction to the first wrapper unit 12 of the process indicated by the process ID of the source (S33).

The first wrapper unit 12 that has received the inference start instruction executes the inference using the model object (S34). The AI framework 13 executes the CUDA library 15 via the second wrapper unit 14 to use the GPU 17, thereby executing the inference processing (S34A, S35).

Then, when the second wrapper unit 14 hooks the CUDA API from the AI framework 13 (S36), the second wrapper unit 14 updates the internal variables of a state and the like from the CUDA API and the argument based on the loaded transition pattern. Then, when the second wrapper unit 14 detects a core start pattern (S37), the second wrapper unit 14 transmits a core start notification and the process ID to the scheduler unit 21 (S38).

If the core start notification queue 218 is empty, the scheduler unit 21 transmits a core start instruction to the second wrapper unit 14 of the process 10 indicated by the process ID (S39). Note that, the scheduler unit 21 adds the process ID to the core start notification queue 218 if the core start notification queue 218 is not empty.

The second wrapper unit 14 that has received the core start instruction executes the CUDA library 15 to use the GPU 17 (S40).

Then, when the second wrapper unit 14 detects a core end pattern (S42), the second wrapper unit 14 transmits a core end notification and the process ID to the scheduler unit 21 (S43). Note that, the scheduler unit 21 that has received the core end notification and the process ID deletes the corresponding process ID in the core start notification queue 218. Thereafter, the scheduler unit 21 selects one of the process IDs in the core start notification queue 218, and transmits a core start instruction to the second wrapper unit 14 of the process 10 indicated by the selected process ID.

Thereafter, the second wrapper unit 14 executes the CUDA library 15 to use the GPU 17 if the CUDA API is not being executed at the time of updating the internal variables (S44 to S46). Then, the second wrapper unit 14 executes the CUDA API, and returns a return value to the AI framework 13. The AI framework 13 that has executed the inference returns an inference result to the application 11 via the first wrapper unit 12 (S47, S48).

Here, in the case of the inference for the second and subsequent times, the second wrapper unit 14 detects a core start and a core end based on the transition pattern corresponding to the model name when the CUDA API is hooked from the AI framework 13. Then, the second wrapper unit 14 and the scheduler unit 21 control the execution of the core processing in such a manner that the core processing does not overlap with another core processing. However, in the case of the initial inference, the second wrapper unit 14 directly executes the core processing even if the CUDA API is hooked from the AI framework 13. The reason is as follows. When the AI framework 13 executes the inference, a GPU usage pattern is optimized to avoid waste at the time of using the GPU 17 while executing the inference processing in the initial inference. Therefore, while the processing is carried out in the order of seconds in the initial inference, the processing is carried out in the order of several tens to several hundreds of milliseconds in the inference for the second and subsequent times. For example, the initial inference is a process longer than the inference for the second and subsequent times. Therefore, in the initial inference, the second wrapper unit 14 directly executes the core processing to allow parallel execution with another inference processing so that another core processing is not blocked in the order of seconds.

[Sequence of Inference of Multiple Processes]

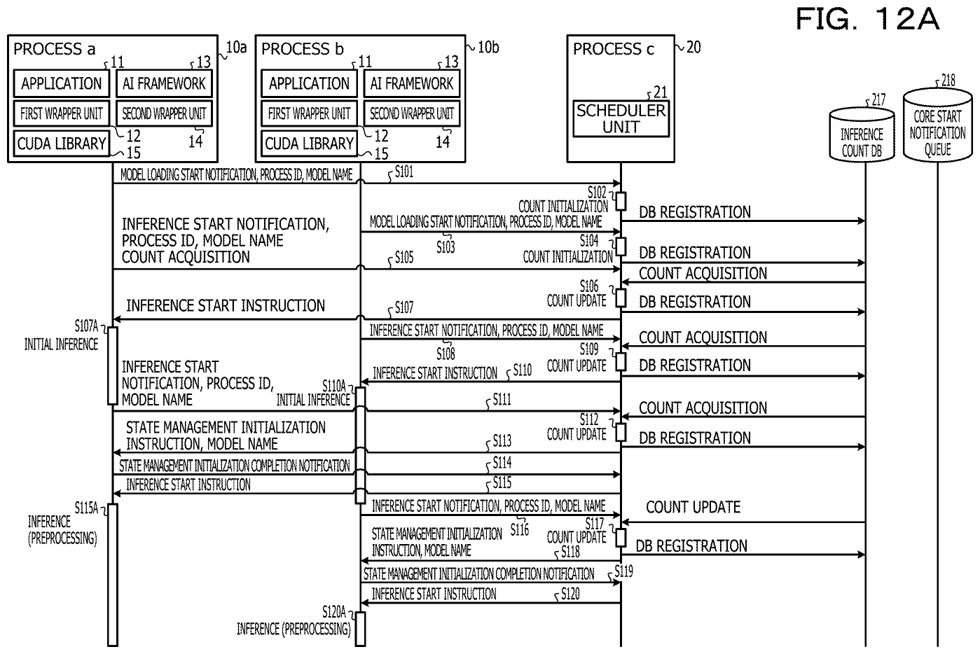

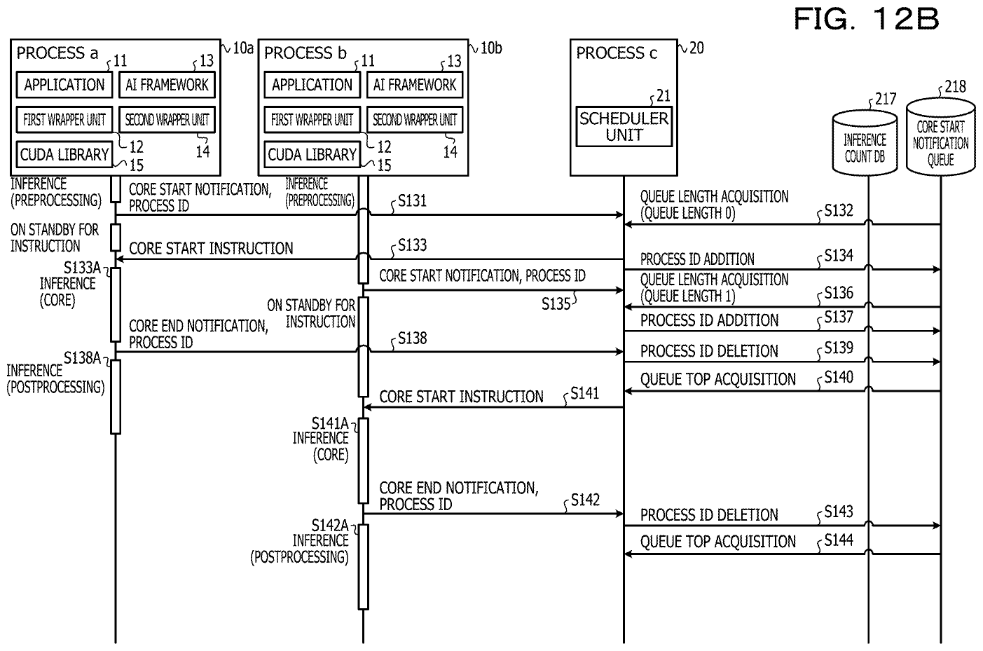

Here, an exemplary sequence of the inference of a plurality of the processes 10 will be described with reference to FIGS. 12A and 12B. FIGS. 12A and 12B are diagrams illustrating an exemplary sequence of the inference of multiple processes. Processes that execute the inference are assumed to be a process a (10a) and a process b (10b). The scheduler unit 21 is assumed to be a process c (20).

As illustrated in FIG. 12A, first, the process a transmits a model loading start notification, a process ID, and a model name to the scheduler unit 21 (S101). For example, in the process a, the application 11 transmits a model loading instruction and a path of a model to be loaded to the first wrapper unit 12. Then, the first wrapper unit 12 hooks the model loading instruction from the application 11. Then, the first wrapper unit 12 obtains a model name to be loaded from the path-model correspondence table 125 and the path of the model to be loaded, and transmits the model loading start notification, the process ID, and the model name to the scheduler unit 21.

The scheduler unit 21 that has received the model loading start notification, the process ID, and the model name initializes the count of the inference count for the combination of the process ID and the model name (S102). Then, the scheduler unit 21 registers, in the inference count DB 217, the inference count of zero set for the combination of the process ID and the model name.

Furthermore, the process b transmits a model loading start notification, a process ID, and a model name to the scheduler unit 21 (S103). Note that, implementation contents in the process b at the time of implementing S103 are similar to those in the case of S101 in the process a, and thus descriptions thereof will be omitted. The scheduler unit 21 that has received the model loading start notification, the process ID, and the model name of the process a initializes the count of the inference count for the combination of the process ID and the model name (S104). Then, the scheduler unit 21 registers, in the inference count DB 217, the inference count of zero set for the combination of the process ID and the model name.

Subsequently, the process a transmits an inference start notification, the process ID, and the model name to the scheduler unit 21 (S105). For example, the first wrapper unit 12 uses the model load API of the AI framework 13 to load a model object with the model name to be loaded. Thereafter, the first wrapper unit 12 adds information regarding the hook API and the model name to the loaded model object to generate a hook model. Then, the first wrapper unit 12 returns the hook model API (111) to the application 11. When the application 11 executes the initial inference using the hook model API (111), in the first wrapper unit 12, the hook model hooks an inference start instruction, and the inference start notification, the process ID, and the model name are transmitted to the scheduler unit 21. Thereafter, the first wrapper unit 12 stands by for an instruction from the scheduler unit 21.

The scheduler unit 21 that has received the inference start notification, the process ID, and the model name obtains the count of the inference count for the combination of the process ID and the model name from the inference count DB 217. Then, the scheduler unit 21 updates the count of the inference count to a value “1” obtained by adding one thereto (S106), and registers it in the inference count DB 217. Then, since the inference count is “1” (first time), the scheduler unit 21 transmits an inference start instruction to the first wrapper unit 12 of the process 10a indicated by the process ID (S107).

The process a that has received the inference start instruction executes the initial inference (S107A). For example, the first wrapper unit 12 that has received the inference start instruction executes the inference using the model object. The AI framework 13 executes the inference processing using the GPU 17. Then, the first wrapper unit 12 returns an inference result to the application 11 upon reception thereof.

Furthermore, the process b transmits an inference start notification, the process ID, and the model name to the scheduler unit 21 (S108). Note that, implementation contents in the process b at the time of implementing S108 are similar to those in the case of S105 in the process a, and thus descriptions thereof will be omitted. The scheduler unit 21 that has received the inference start notification, the process ID, and the model name obtains the count of the inference count for the combination of the process ID and the model name from the inference count DB 217. Then, the scheduler unit 21 updates the count of the inference count to a value “1” obtained by adding one thereto (S109), and registers it in the inference count DB 217. Then, since the inference count is “1” (first time), the scheduler unit 21 transmits an inference start instruction to the first wrapper unit 12 of the process b indicated by the process ID (S110).

The process b that has received the inference start instruction executes the initial inference (S110A). For example, the first wrapper unit 12 that has received the inference start instruction executes the inference using the model object. The AI framework 13 executes the inference processing using the GPU 17. Then, the first wrapper unit 12 returns an inference result to the application 11 upon reception thereof.

The process a that has completed the initial inference transmits the inference start notification, the process ID, and the model name to the scheduler unit 21 to execute the inference for the second and subsequent times (S111). For example, the application 11 executes the inference for the second and subsequent times using the hook model API (111). Then, in the first wrapper unit 12, the hook model hooks the inference start instruction, and the inference start notification, the process ID, and the model name are transmitted to the scheduler unit 21. Thereafter, the first wrapper unit 12 stands by for an instruction from the scheduler unit 21.

The scheduler unit 21 that has received the inference start notification, the process ID, and the model name updates the count of the inference count for the combination of the process ID and the model name to a value obtained by adding one (S112), and registers it in the inference count DB 217. Then, since the inference count is “2” or more, the scheduler unit 21 transmits a state management initialization instruction and the model name to the second wrapper unit 14 of the process a indicated by the process ID (S113). Then, the scheduler unit 21 stands by for a response from the second wrapper unit 14.

In the process a, the second wrapper unit 14 that has received the state management initialization instruction and the model name loads the transition pattern corresponding to the model name from the transition pattern DB, initializes the internal variables, and transmits a state management initialization completion notification to the scheduler unit 21 (S114).

The scheduler unit 21 that has received the state management initialization completion notification transmits an inference start instruction to the first wrapper unit 12 of the process a indicated by the process ID of the source (S115).

In the process a, the first wrapper unit 12 that has received the inference start instruction executes preprocessing using the model object (S115A).

The process b that has completed the initial inference transmits the inference start notification, the process ID, and the model name to the scheduler unit 21 to execute the inference for the second and subsequent times (S116). Note that implementation contents in the process b at the time of implementing S116 are similar to those in the case of S111 in the process a, and thus descriptions thereof will be omitted.

The scheduler unit 21 that has received the inference start notification, the process ID, and the model name updates the count of the inference count for the combination of the process ID and the model name to a value obtained by adding one (S117), and registers it in the inference count DB 217. Then, since the inference count is “2” or more, the scheduler unit 21 transmits a state management initialization instruction and the model name to the second wrapper unit 14 of the process b indicated by the process ID (S118). Then, the scheduler unit 21 stands by for a response from the second wrapper unit 14.

In the process b, the second wrapper unit 14 that has received the state management initialization instruction and the model name loads the transition pattern corresponding to the model name from the transition pattern DB, initializes the internal variables, and transmits a state management initialization completion notification to the scheduler unit 21 (S119).

The scheduler unit 21 that has received the state management initialization completion notification transmits an inference start instruction to the first wrapper unit 12 of the process b indicated by the process ID of the source (S120).

In the process b, the first wrapper unit 12 that has received the inference start instruction executes preprocessing using the model object (S120A).

As illustrated in FIG. 12B, in the process a executing the preprocessing, the second wrapper unit 14 transmits a core start notification and the process ID to the scheduler unit 21 when it detects a core start pattern (S131).

The scheduler unit 21 that has received the core start notification and the process ID from the process a obtains a queue length from the core start notification queue 218 (S132). Here, the queue length is assumed to be zero. Then, since the core start notification queue 218 is empty, the scheduler unit 21 transmits a core start instruction to the second wrapper unit 14 of the process a indicated by the process ID (S133). In addition, the scheduler unit 21 adds the process ID of the process a to the core start notification queue 218 (S134). Then, the second wrapper unit 14 of the process a that has received the core start instruction executes core processing (S133A).

Furthermore, in the process b executing the preprocessing, the second wrapper unit 14 transmits a core start notification and the process ID to the scheduler unit 21 when it detects a core start pattern (S135).

The scheduler unit 21 that has received the core start notification and the process ID from the process b obtains a queue length from the core start notification queue 218 (S136). Here, the queue length is one. Then, since the core start notification queue 218 is not empty, the scheduler unit 21 adds the process ID of the process b to the core start notification queue 218 (S137).

In the process a executing the core processing, the second wrapper unit 14 transmits a core end notification and the process ID to the scheduler unit 21 when it detects a core end pattern (S138). Then, the second wrapper unit 14 proceeds to executing postprocessing (S138A).

The scheduler unit 21 that has received the core end notification and the process ID from the process a deletes the corresponding process ID in the core start notification queue 218 (S139). Then, the scheduler unit 21 obtains the first process ID of the core start notification queue 218 (S140). Here, the obtained process ID is the process ID of the process b. Then, the scheduler unit 21 transmits a core start instruction to the second wrapper unit 14 of the process b indicated by the process ID (S141). Then, the second wrapper unit 14 of the process b that has received the core start instruction executes core processing (S141A).

In the process b executing the core processing, the second wrapper unit 14 transmits a core end notification and the process ID to the scheduler unit 21 when it detects a core end pattern (S142). Then, the second wrapper unit 14 proceeds to executing postprocessing (S142A).

The scheduler unit 21 that has received the core end notification and the process ID from the process b deletes the corresponding process ID in the core start notification queue 218 (S143). Then, the scheduler unit 21 continuously obtains the first process ID of the core start notification queue 218 (S144). Then, upon acquisition of the process ID, the scheduler unit 21 is to issue the next core start instruction to the process 10 indicated by the process ID.

[Effects of Embodiment]

In this manner, according to the embodiment described above, the server 1 stores, in the transition pattern DB 145, a message pattern to be used to determine the start and end of the core processing using the GPU 17, which is the core processing taking a role as a core part of the inference processing using the GPU 17. The server 1 monitors a message output from the application that executes the inference processing. The server 1 determines, using the message pattern stored in the transition pattern DB 145, start and end timing of the core processing from the message pattern obtained by monitoring. When the server 1 has determined the start timing of the core processing, the server 1 starts the core processing if there is no process executing another core processing, and accumulates a process identifier for identifying the process of the core processing in the core start notification queue 218 if there is a process executing another core processing. According to such a structure, the server 1 is enabled to suppress an increase in processing time caused by duplicate execution of inference processes even when one GPU 17 executes multiple inference processes in a multiplex manner. In particular, for example, the server 1 determines the start and end timing of the core processing using the transition pattern DB 145, whereby the cost needed for the preliminary investigation for investigating a core processing time in advance may be removed and an increase in processing time caused by the interference of the core processing may be suppressed.

Furthermore, according to the embodiment described above, in a case where the server 1 has determined the end timing of the core processing, it deletes the process identifier of the process executing the core processing for which the end timing is determined from the core start notification queue 218. According to such a configuration, the server 1 is enabled to obtain the end timing of the core processing in real time, start the next core processing immediately, and reliably suppress an increase in processing time caused by duplicate execution of inference processes.

Furthermore, according to the embodiment described above, the message pattern to be used to determine the start and end of the core processing includes a case of obtaining a specific message using the GPU 17, a case of executing the specific message using the GPU 17 to obtain a return value, and a case where execution of the specific message using the GPU 17 is complete in the GPU 17. According to such a configuration, the server 1 is enabled to reliably suppress an increase in processing time caused by duplicate execution of various inference processes by using a start pattern and an end pattern of core processing in various types.

### OTHERS

Note that each of the components of the first wrapper unit 12, the second wrapper unit 14, and the scheduler unit 21 included in the server 1 illustrated is not necessarily physically configured as illustrated. For example, specific aspects of separation and integration of the respective devices are not limited to the illustrated ones, and all or a part thereof may be functionally or physically separated and integrated in any unit depending on various loads, use states, or the like. For example, the state management unit 142 may be separated into an initialization unit that initializes state management, a processing unit for a time when a core start pattern is detected, a processing unit for a time when a core end pattern is detected, and a processing unit for a case where neither a core start nor a core end is detected. Furthermore, the model identification unit 122 and the hook model generation unit 123 may be integrated as one unit. Furthermore, a storage unit (not illustrated) that stores the transition pattern DB 145 and the like may be connected via a network as an external device of the server 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus that uses a graphical processing unit (GPU) for inference processing, the information processing apparatus comprising:
a memory; and
a processor coupled to the memory and configured to:
monitor a message output from an application that executes the inference processing,
determine, from a pattern of the message, timing of a start and an end of core processing that uses the GPU, the core processing serving as a core of the inference processing, and
start the core processing when there is no process executing another core processing and accumulates a process identifier that identifies a process of the core processing in a queue when there is a process executing the another core processing in a case where the timing of the start of the core processing is determined.

2. The information processing apparatus according to claim 1, wherein
the processor deletes, from the queue, the process identifier of the process that executes the core processing for which the timing of the end is determined when the timing of the end of the core processing is determined.

3. The information processing apparatus according to claim 1, wherein
the memory stores the pattern of the message to be used to determine the start and the end of the core processing, and
the processor determines the timing of the start and the end of the core processing from the pattern of the message based on the pattern of the message stored in the memory.

4. The information processing apparatus according to claim 1, wherein
the pattern of the message includes a case of obtaining a specific message that uses the GPU, a case of executing the specific message that uses the GPU to obtain a return value, and a case where execution of the specific message that uses the GPU is complete in the GPU.

5. A non-transitory computer-readable storage medium storing a program that causes a processor included in an information processing apparatus that uses a graphical processing unit (GPU) for inference processing to execute a process, the process comprising:
monitoring a message output from an application that executes the inference processing,
determining, from a pattern of the message, timing of a start and an end of core processing that uses the GPU, the core processing serving as a core of the inference processing, and
starting the core processing when there is no process executing another core processing and accumulates a process identifier that identifies a process of the core processing in a queue when there is a process executing the another core processing in a case where the timing of the start of the core processing is determined.

6. A multiplex control method executed by a processor included in an information processing apparatus that uses a graphical processing unit (GPU) for inference processing, the multiplex control method comprising:
monitoring a message output from an application that executes the inference processing,
determining, from a pattern of the message, timing of a start and an end of core processing that uses the GPU, the core processing serving as a core of the inference processing, and
starting the core processing when there is no process executing another core processing and accumulates a process identifier that identifies a process of the core processing in a queue when there is a process executing the another core processing in a case where the timing of the start of the core processing is determined.

7. The multiplex control method according to claim 6, further comprising
deleting, from the queue, the process identifier of the process that executes the core processing for which the timing of the end is determined when the timing of the end of the core processing is determined.

8. The multiplex control method according to claim 6, further comprising
storing the pattern of the message to be used to determine the start and the end of the core processing,
wherein the determining includes determining the timing of the start and the end of the core processing from the pattern of the obtained message based on the pattern of the message stored in the memory.

9. The multiplex control method according to claim 6,
wherein the pattern of the message includes a case of obtaining a specific message that uses the GPU, a case of executing the specific message that uses the GPU to obtain a return value, and a case where execution of the specific message that uses the GPU is complete in the GPU.
